(19) United States
(12) Patent Application Publication
(10) Pub. No.: US 2007/0217603 A1
(43) Pub. Date: Sep. 20, 2007

(54) Decryption key reuse in encrypted digital data stream distribution systems

(75) Inventor: Fabrice M. R. Quinard, Los Gatos, CA (US)

Correspondence Address: THELEN REID BROWN RAYSMAN & STEINER LLP, P. O. BOX 640640, SAN JOSE, CA, 95164-0640, US

(73) Assignee: Terayon Communication Systems, Inc.

(21) Appl. No.: 11/377,532

(22) Filed: Mar. 15, 2006

(51) Int. Cl. H04L 9/00

(52) U.S. Cl. 380/42; 380/259

(57) ABSTRACT

A data processing apparatus for a first encrypted digital datum in a digital data stream distributed in a distributed system. The apparatus includes a key extractor for obtaining a symmetric encryption key used to encrypt the first encrypted digital datum; a decryption system for creating a plaintext digital datum from the first encrypted digital datum using the symmetric encryption key; a processing system for operating on the plaintext digital datum to produce a modified plaintext digital datum; an encryption system for creating second encrypted digital datum from the modified plaintext digital datum using the symmetric encryption key; and a transmitter for introducing the second encrypted digital datum into digital data stream.

### CROSS-REFERENCE TO RELATE APPLICATIONS

(Not applicable)

### BACKGROUND OF INVENTION

The invention relates generally to encryption systems for digital data streams, and more specifically to reuse of an encryption key in digital data stream distribution systems.

Television program distribution systems have been transitioning from analog broadcast to digital distribution systems that include cable, satellite and other high bandwidth, multi-demographic (e.g., geography,) distribution systems. In addition, television programming includes premium content that is available for additional fees or subscription basis.

When the television signal was in analog format, premium content was scrambled at an origination point and descrambled at authorized consumer sites. As the television signal has transitioned to digital signals, the digital content has been encrypted using well-known techniques. For example, in a cable distribution system in which programming originates at a head end and is viewed at a subscriber location, clear programs (unencrypted) are digitized as necessary and the digital data stream with the programming content is encrypted using a symmetric key. The encrypted digital data stream and an encoded key are distributed to the subscribers who decode the key and decrypt the appropriate content for viewing. DVB SimulCrypt is representative of one way such a system may be implemented and are each expressly incorporated by reference herein for all purposes.

Such a system works well for an end-to-end model that transmits programming from the head end directly to the subscriber. However, in many applications, it is desirable to have a master head end distribute content to several intermediate head ends which each service a set of subscribers grouped by one or more shared demographic characteristic. For example, it is a common model to have a national master end that distributes programming to regional head ends that each service subscribers in a particular region of the country. Other demographic categories may be used to group similar subscribers, for example age groups, economic status, and so forth.

When there are intermediate head ends which have a desire to modify received programming and customize programming for the subscribers in a specific demographic zone, the intermediate head end must have access to the clear programming in order to insert ‘local’ programming or ‘local’ advertising (such as when the demographics are geography based).

for those digital systems that have encrypted the digital datastream at the master head end, the intermediate head end is unable to customize programming for its set of subscribers. That is, it is unable to do so without decrypting the encrypted digital datastream. Once it is decrypted, the intermediate head end may modify, supplement or delete programming in conventional fashion. However, the digital datastream is now clear and unprotected as it was in the distribution system from the master head end to the intermediate head end. The intermediate head end may desire to reencrypt the modified digital datastream to control access to the modified programming distributed to the set of subscribers serviced by the intermediate head end.

The current model for encrypting digital datastreams is direct master head end to subscriber distribution without intermediate head ends. An operator of the distribution system pays a third party significant licensing fees for access to an encryption key generation system that is installed at the master head end. Extensions of the current model to a distribution system having one or more intermediate head ends would result in installation of multiple encryption key generation systems. These generators would be installed at the master head end, and at each intermediate head end. As the fees for these generators are significant, such a solution may make the entire distribution far too costly to be commercially viable.

### SUMMARY OF THE INVENTION

The present invention is a simple, efficient solution to the problem of providing decryption/reencryption functionality at each intermediate head end in an encrypted digital data stream distribution system.

An alternate preferred embodiment of the invention includes a method of processing a first set of encrypted digital data in a digital data stream distributed in a distribution system. The method includes obtaining a symmetric encryption key used to encrypt the first set of encrypted digital datum; creating a set of plaintext digital data from the first set of encrypted digital data using the symmetric encryption key; operating on the set of plaintext digital data to produce a set of modified plaintext digital data; creating a second set of encrypted digital data from the set of modified plaintext digital data using the symmetric encryption key; and introducing the second set of encrypted digital data into the digital data stream.

These and other novel aspects of the present invention will be apparent to those of ordinary skill in the art upon review of the drawings and the remaining portions of the application.

### BRIEF DESCRIPTION OF THE DRAWINGS

Many advantages of the present invention will be apparent to those skilled in the art with a reading of this specification in conjunction with the attached drawings, wherein like reference numerals are applied to like elements, and wherein:

FIG. 1 is a schematic block diagram illustrating a preferred embodiment of an encrypted digital data stream distribution system; and

FIG. 2 is a schematic block diagram of a regional head end as part of the distribution system illustrated in FIG. 1.

### DETAILED DESCRIPTION OF THE PREFERRED EMBODIMENT

Embodiments of the present invention are described herein in the context of methods and systems for decryption key reuse in encrypted data stream distribution systems. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business- related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

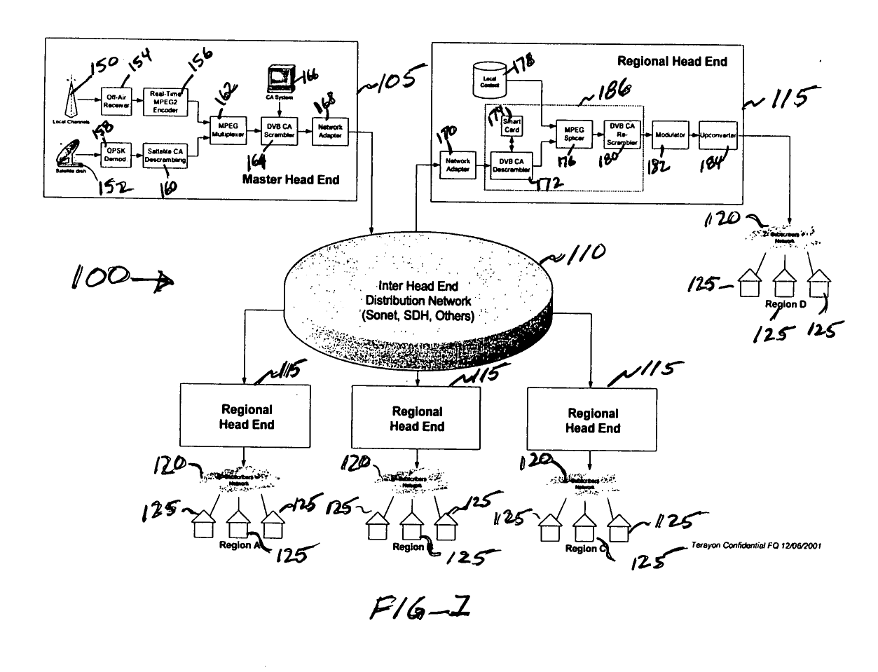

FIG. 1 is a schematic block diagram illustrating a preferred embodiment of an encrypted digital data stream distribution system 100. Distribution system 100 includes a master head end 105, an inter head end distribution network 110, one or more regional head ends 115, one or more subscriber networks 120, each having a plurality of subscribers 125. Master head end 105 in a television programming application includes programming sources (e.g., local channel transmitters 150, satellite broadcast 152, etc.) as well known. While the preferred embodiment is described in the context of television programming distribution, other applications may distribute other types of data.

Master head end 105 includes receivers and digitizers appropriate for each programming source. For example, an off-air receiver 154 receives local channel broadcasts from local channel transmitters 150 and provided these to a real-time MPEG2 encoder 156. Similarly, a QPSK demodulator 158 receives satellite broadcasts from satellite broadcast 152 and a satellite descrambling system 160 converts the encoded digital transmission into clear digital programming. An MPEG multiplexer 162 multiplexes the clear digital programming from all sources into a digital data stream. A DVB CA scrambler 164, working in conjunction with a proprietary CA system 166, encrypts the clear digital programming with a time-varying symmetric key into an encrypted digital data stream. The encrypted digital data stream is sent to a network adapter 168 appropriate for the protocol of the distribution system.

Specifically, inter head end distribution network 110 may use any number of protocols, including for example Sonet, SDH, or others, and network adapter 168 packages the encrypted digital data stream appropriately for transmission through inter head end 110 to regional head ends 115.

Each regional head end 115 includes a network adapter 170 which serves as a key extractor for extracting the encrypted digital data stream from the inter head end distribution network 110. A DVB CA descrambler 172, working with a smart card 174 in well-known fashion, decrypts the encrypted digital data stream to create a clear, or plaintext, digital data stream. An MPEG splicer 176 coupled to descrambler 172 and to a local programming digital content source 178 inserts additional regional content into the digital data stream to produce a modified digital data stream. While MPEG splicer 176 is shown adding to the existing programming of the digital data stream, a more generic programming processor used in place of MPEG splicer 176 could be used additionally to delete or alter the programming in the clear digital data stream in the production of the modified digital data stream.

The preferred embodiment has a DVB CA rescrambler 180 coupled to an output of MPEG splicer 176. At rescrambler 180, rather than using a new DVB CA scrambler 164 and CA system 166 as was used in master head end 105 at additional cost and installation difficulties, regional head end 115 simply reuses the symmetric key extracted from descrambler 172 to reencrypt the modified digital data stream. In the preferred embodiment, the encryption key is symmetric meaning that the same key play be used to encrypt and decrypt. While in the preferred embodiment regional head end 115 employs the exact same key in rescrambler 180 as was used in descrambler 172, it is possible in some embodiments that a derivative encryption key may be used in rescrambler 180. A derivative encryption key is one which is derived from the key generated by scrambler 164 rather being newly generated. The derivative encryption key remains symmetric in that subscribers 125 will be able to extract the derivative encryption key and use it to decrypt appropriate programming.

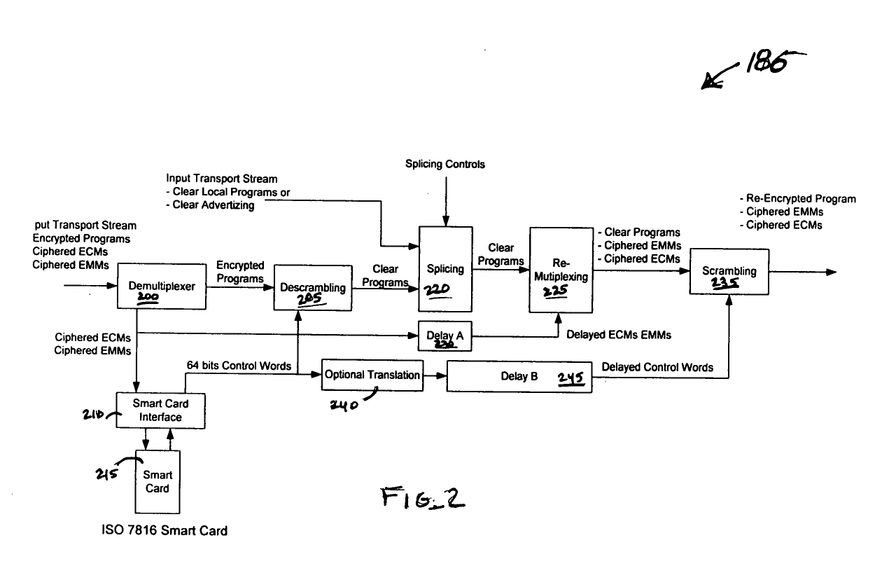

Each regional head end 115 includes a modulator 182 and an upconverter 184 to modulate, convert and transmit the reencrypted modified digital data stream to subscriber network 120. The specific functions described in decryption/encryption system 186, which is shown to include DVB CA descrambler 172, smart card 174, MPEG splicer 176 and DVB CA re-scrambler 180, will be described in more detail in FIG. 2.

Regional head end 115 transmits the modulated, upconverted, encrypted modified digital data stream to subscribers network 120, which then distributes the digital stream to each subscriber 125. In well-known fashion, each subscriber demodulates, down-converts, and decrypts specific programming in the modified digital data stream for consumption. Each subscriber 125 has access to the programming provided from master head end 105, as well as from its regional head end 115. While the preferred embodiment separates subscribers 125 into subdivisions of groups based upon a similar demographic characteristic (in this case it is geographic location), as discussed above other intermediate head ends 115 could be provided to other groups of subscribers 125 based upon other shared demographic characteristic.

FIG. 2 is a schematic block diagram of decrypting/reencrypting system 186 of regional head end 115 illustrated as part of the distribution system illustrated in FIG. 1. Decrypting/reencrypting system 186 includes a demultiplexer 200 for receiving an input transport stream, including a digital datum, that includes the encrypted programming, ciphered ECMs and ciphered EMMs. Demultiplexer 200 separates out the encrypted programming, and a smart card interface 210 receives the ciphered ECMs and EMMs. Smart card interface 210 works in conjunction with an appropriate smart card 215 to extract 64-bit control words used for decryption.

Descrambler 205 receives the encryption key and outputs clear (i.e., plaintext) programming to a splicer 220. Splicer 220 combines the clear programming from descrambler 205 with clear local programs or clear advertising. In other applications, splicer 220 may be a program processor to alter, modify or delete content from the clear programming. Splicer 220 outputs a modified (but clear, or plaintext) digital data stream to remultiplexer 225. Remultiplexer 225 takes the clear programming and multiplexes it with delayed ciphered ECMs and EMMs output from a first delay 230 coupled to demultiplexer 200.

Remultiplexer 225 outputs the modified clear plaintext programming along with the ciphered EMMs and ECMs to a rescrambler 235. In addition to the multiplexed, modified plaintext digital data stream, scrambler 235 receives a delayed, optionally translated, encryption key output from interface 210. An optional translator 240 receives the encryption key from interface 210 and outputs a derivative symmetric encryption key. In some embodiments, translator 240 outputs the same encryption key, though in other cases it may be desirable to modify the encryption key.

The encryption key (translated or not) is output from translator 240 and delayed using second delay 245 and then provided to rescrambler 235 for transmission into the data stream. Because the encryption key and the ciphered ECMs and EMMs are time-varying, delay 230 and delay 240 align the ciphered ECMs and EMMs, and the encryption key to the digital data stream. This is to optionally compensate for potential delay introduced to the data stream by the processing chain. Rescrambler 235 outputs the reencrypted modified digital data stream without use of equipment to regenerate new, unique encryption keys.

The above are exemplary modes of carrying out the invention and are not intended to be limiting. It will be apparent to those of ordinary skill in the art that modifications thereto can be made without departure from the spirit and scope of the invention as set forth in the following claims.

What is claimed is:

1. A data processing apparatus for a first encrypted digital datum in a digital data stream distributed in a distribution system, comprising:
a key extractor for obtaining a symmetric encryption key used to encrypt the first encrypted digital datum;
a decryption system for creating a plaintext digital datum from the first encrypted digital datum using said symmetric encryption key;
a processing system for operating on said plaintext digital datum to produce a modified plaintext digital datum;
an encryption system for creating a second encrypted digital datum from said modified plaintext digital datum using said symmetric encryption key; and
a transmitter for introducing said second encrypted digital datum into the digital data stream.

2. The data processing apparatus of claim 1 wherein said symmetric encryption key is obtained from the digital data stream and wherein said transmitter introduces said symmetric encryption key into the digital data stream.

3. A data processing apparatus for a first set of encrypted digital data in a digital data stream distributed in a distribution system, comprising:
a key extractor for obtaining a symmetric encryption key used to encrypt the first set of encrypted digital data;
a decryption system for creating a set of plaintext digital data from the first set of encrypted digital data using said symmetric encryption key;
a processing system for operating on said set of plaintext digital data to produce a set of modified plaintext digital data;
an encryption system for creating a second set of encrypted digital data from said set of modified plaintext digital data using said symmetric encryption key; and
a transmitter for introducing said second set of encrypted digital data into the digital data stream.

4. The data processing apparatus of claim 3 wherein said symmetric encryption key is obtained from the digital data stream and wherein said transmitter introduces said symmetric encryption key into the digital data stream.

5. The data processing apparatus of claim 3 wherein said processing system alters a datum of said first set of plaintext digital data.

6. The data processing apparatus of claim 3 wherein said processing system adds a plaintext datum to said first set of encrypted digital data.

7. The data processing apparatus of claim 3 wherein said processing system removes a plaintext datum from said first set of encrypted digital data.

8. A method of processing a first set of encrypted digital data in a digital data stream distributed in a distribution system, comprising:
obtaining a symmetric encryption key used to encrypt the first set of encrypted digital datum;
creating a set of plaintext digital data from the first set of encrypted digital data using said symmetric encryption key;
operating on said set of plaintext digital data to produce a set of modified plaintext digital data;
creating a second set of encrypted digital data from said set of modified plaintext digital data using said symmetric encryption key; and
introducing said second set of encrypted digital data into the digital data stream.

9. A digital video distribution system, comprising:
a head-end system having a digital video source for generating a set of plaintext digital video data to be distributed to a set of consumers in two geographically distinct regions;
an encryption system for encrypting said set of plaintext digital video data with a symmetric encryption key to form a first set of encrypted digital data;
a distribution system configured to distribute said first set of encrypted digital data and said symmetric encryption key to a first regional processing center and to a second regional processing center;
a first regional recryption system at said first regional processing center including:
a key extractor for obtaining said symmetric encryption key;
a decryption system for recreating said set of plaintext digital video data from said first set of encrypted digital data using said symmetric encryption key;
a processing system for operating on said set of plaintext digital data to produce a first set of modified plaintext digital data;
an encryption system for creating a second set of encrypted digital encryption from said first set of modified plaintext digital data using said symmetric encryption key; and
a transmitter for transmitting said second set of encrypted digital data and said symmetric encryption key to a first subset of consumers in a first geographic region; and
a second regional recryption system at said first regional processing center including:
a key extractor for obtaining said symmetric encryption key;
a decryption system for recreating said set of plaintext digital video data from said first set of encrypted digital data using said symmetric encryption key;
a processing system for operating on said set of plaintext digital data to produce a second set of modified plaintext digital data different from said first set of modified plaintext digital data;
an encryption system for creating a third set of encrypted digital data from said second set of modified plaintext digital data using said symmetric encryption key; and
a transmitter for transmitting said third set of encrypted digital data to a second subset of consumers in a second geographic region.

10. The digital video distribution system of claim 9 further comprising:
a decoder for each consumer of said first subset of consumers to extract said first set of modified plaintext digital data; and
a decoder for each consumer of said second subset of consumers to extract said second set of modified plaintext digital data.

11. Apparatus for processing a first set of encrypted digital data in a digital data stream distributed in a distribution system, comprising:
means for extracting a symmetric encryption key used to encrypt the first set of encrypted digital datum;
means, coupled to said extracting means, for creating a set of plaintext digital data from the first set of encrypted digital data using said symmetric encryption key;
means, coupled to said plaintext creating means, for operating on said set of plaintext digital data to produce a set of modified plaintext digital data;
means, coupled to said operating means, for creating a second set of encrypted digital data from said set of modified plaintext digital data using said symmetric encryption key; and
means, coupled to said means for creating said second set of encrypted digital data, for introducing said second set of encrypted digital data into the digital data stream.
